(19) United States
(12) Patent Application Publication
(10) Pub. No.: US 2023/0022356 A1
(43) Pub. Date: Jan. 26, 2023

(54) METHOD AND SYSTEM FOR HUMAN ACTIVITY RECOGNITION IN AN INDUSTRIAL SETTING

(71) Applicant: Hitachi, Ltd., Tokyo (JP)

(72) Inventors: Andrew WALKER, Sunnyvale, CA (US); Joydeep ACHARYA, Milpitas, CA (US)

(73) Assignee: Hitachi, Ltd.

(21) Appl. No.: 17/372,259

(22) Filed: Jul. 9, 2021

(51) Int. Cl. G06K 9/00; G06K 9/62

(52) U.S. Cl. CPC G06K 9/00369; G06K 9/00342; G06K 9/6215; G06K 9/6256

(57) ABSTRACT

Example implementations described herein involve a system for training and managing machine learning models in an industrial setting. Specifically, by leveraging the similarity across certain production areas, it is possible to group such areas together to train models efficiently that use human pose data to predict human activities or specific task(s) that the workers are engaged in. Example implementations remove previous methods of independent model construction for each production area and takes advantage of the commonality amongst different environments.

### BACKGROUND

### Field

The present disclosure is generally directed to industrial systems, and more specifically, to systems and methods for management and recognition of human activities.

### Related Art

The goal of human activity recognition (HAR) is to classify the activity a human is doing at a particular moment or over a window of time. These activities are typically drawn from the action space, [symbol] , of all possible actions that the person could be performing in a certain context. The umbrella under which HAR covers is vast, as illustrated by the following examples.

In healthcare, an HAR model could aim at identifying if a patient has currently fallen over or is sleeping. For health care providers, an HAR model might try to see if the provider is performing certain actions in a correct order (e.g., washing their hands before putting on their gloves). In sports, an HAR model might try to discern if the human is walking, running, or jumping. In an industrial setting, an HAR model might be concerned with observing how quickly workers are performing certain actions, e.g., picking up a box, hammering a nail into an assembly part, etc. In human-robot collaboration, an HAR model could be used to aid such a system in helping the robot identify whether the accompanying human has performed a task yet.

### SUMMARY

Aspects of the present disclosure can involve a method, which can include, for receipt of sensor data of a plurality of workers operating across a plurality of physical areas from a plurality of sensors, extracting pose data of the plurality of workers from the sensor data, the pose data indicative of one or more poses of the plurality of workers; determining pose distributions from the extracted pose data; clustering the pose distributions based on similarity to form a plurality of clusters; and training a model for each of the pose distributions of each of the plurality of physical areas to generate a plurality of models, wherein at least a portion of weights used in the plurality of models are shared among ones of the plurality of models belonging to a same cluster of the plurality of clusters and from different ones of the plurality of physical areas.

Aspects of the present disclosure can involve a computer program, having instructions for executing a process, the instructions which can include, for receipt of sensor data of a plurality of workers operating across a plurality of physical areas from a plurality of sensors, extracting pose data of the plurality of workers from the sensor data, the pose data indicative of one or more poses of the plurality of workers; determining pose distributions of each site from the extracted pose data; clustering the pose distributions based on similarity to form a plurality of clusters; and training a model for each of the pose distributions of each of the plurality of physical areas to generate a plurality of models, wherein at least a portion of weights used in the plurality of models are shared among ones of the plurality of models belonging to a same cluster of the plurality of clusters and from different ones of the plurality of physical areas.

Aspects of the present disclosure can involve a system, which can include, for receipt of sensor data of a plurality of workers operating across a plurality of physical areas from a plurality of sensors, means for extracting pose data of the plurality of workers from the sensor data, the pose data indicative of one or more poses of the plurality of workers; means for determining pose distributions of each site from the extracted pose data; clustering the pose distributions based on similarity to form a plurality of clusters; and means for training a model for each of the pose distributions of each of the plurality of physical areas to generate a plurality of models, wherein at least a portion of weights used in the plurality of models are shared among ones of the plurality of models belonging to a same cluster of the plurality of clusters and from different ones of the plurality of physical areas.

Aspects of the present disclosure can involve an apparatus, which can include a processor, configured to, for receipt of sensor data of a plurality of workers operating across a plurality of physical areas from a plurality of sensors, extract pose data of the plurality of workers from the sensor data, the pose data indicative of one or more poses of the plurality of workers; determine pose distributions of each site from the extracted pose data; clustering the pose distributions based on similarity to form a plurality of clusters; and train a model for each of the pose distributions of each of the plurality of physical areas to generate a plurality of models, wherein at least a portion of weights used in the plurality of models are shared among ones of the plurality of models belonging to a same cluster of the plurality of clusters and from different ones of the plurality of physical areas.

Example implementations can thereby prepare input for HAR models that is robust to factors such as camera position or lightning conditions, and facilitate a system of management for HAR models that can adapt to changes in conditions in the production areas. The example implementations can further maximize training of HAR models based on similarity in worker movement by reducing the amount of labeled data required for such models. The example implementations can further appropriately choose features for HAR models based on expected activities in the corresponding production areas. Further, the example implementations can cluster production areas based on similarity of worker activity, while using only a low-dimensional representation of workers that can be readily extracted from a variety of sensors.

### BRIEF DESCRIPTION OF DRAWINGS

FIG. 1 illustrates an example of human activity recognition models in an industrial setting, in accordance with an example implementation.

FIG. 2 illustrates an example tensor of human pose over a window of time, in accordance with an example implementation.

FIG. 3 illustrates an example of transformations to human pose data, in accordance with an example implementation.

FIG. 4 illustrates an example distribution of features extracted from pose data, in accordance with an example implementation.

FIG. 5 illustrates a high-level solution for the management of HAR models, in accordance with an example implementation.

FIG. 6 (A) illustrates an example flow of the feature selection block, in accordance with an example implementation.

FIG. 6 (B) illustrates an example of feature selection input, in accordance with an example implementation.

FIG. 7 illustrates a human activity recognition model architecture, in accordance with an example implementation.

FIG. 8 illustrates an example comparison of different feature-extracted pose distributions, in accordance with an example implementation.

FIG. 9 illustrates an example of the clustering block, in accordance with an example implementation.

FIG. 10 illustrates a flow for the human activity recognition model block, in accordance with an example implementation.

FIG. 11 illustrates an example flow of the model performance check 507, in accordance with an example implementation.

FIG. 12 illustrates an example computing environment with an example computer device suitable for use in some example implementations.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

The classification of human activity is usually done by using available sensor data that can capture or monitor any human(s) in the production area observed by the sensor(s). Machine learning (ML) has been shown to be successful in developing models that can take sensor data observing humans and estimate what actions the worker is doing based on the sensor data (coming from Red Green Blue (RGB) or thermal cameras, Light Detection and Ranging (LiDAR), etc.). Typically, these ML models have as output a conditional probability taking the general form

p_{θ}(a|X),

where a is an action from the action space [symbol] of interest, and X is the sensor data capturing the person of interest. Here, θ represent the parameters of the ML model used. In most applications, these parameters are learned from a collection of labeled data

[symbol]

={( [symbol] , [symbol] ) [symbol] ₌₁.

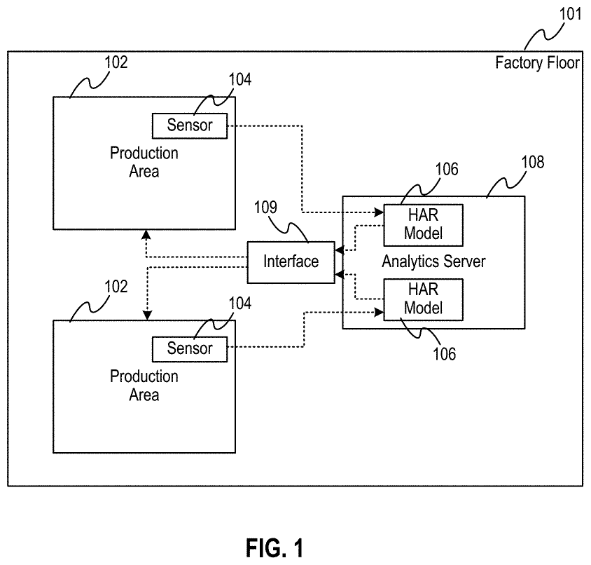

Producing [symbol] can be expensive, as creating labels for sensor data is a time-consuming manual process. With respect to the industrial setting, FIG. 1 highlights how HAR models are used in the Industrial Internet of Things (IIoT) field. Multiple industrial production areas 102 are observed on the factory floor 101 via multidimensional sensor(s) 104 such as RGB camera, LiDAR and so on, and fed into HAR models 106 respectively living on an analytics server 108. These HAR models 106 process the sensor data and output predicted activities or actions the human(s) observed are performing. These predictions are relayed back to the interface 109, which will help them make decisions about adjustments to the corresponding industrial production areas.

In many HAR models, the input X to the model is not the raw sensor data, but significant features extracted from the raw sensor data. While what these features are varies depending on both the sensors used and the application in mind, a common feature of interest is human pose data. This pose data X can be represented as a tensor of shape (T,N,C). Here, T is the number of time frames from which pose data is taken, N is the number of joints along the human body that are being observed, and C is the number of channels observed at each joint and each timestamp. For instance, C=2 in the case where the (x,y)-pixel coordinates of each joint are tracked in a frame. If position, velocity, and acceleration (x,y,z)-vectors are tracked for each joint in a frame, then C=9.

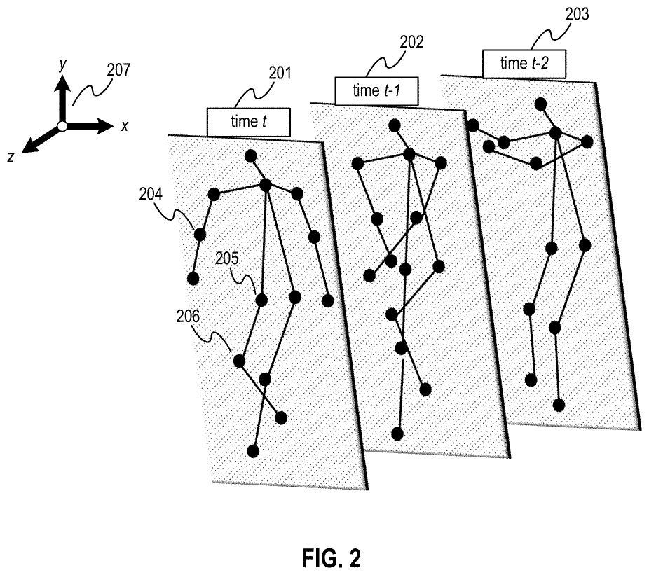

Human pose data provides a lightweight representation of the sensor data that is flexible, capable of being useful for many different applications. As an example, an RGB camera image capturing a human is stored as (H,W,3)-shaped tensor, where H and W are the height and width in pixels of the image, and 3 corresponds to the number of color channels in the image. In many HAR models, N*C«H*W*3, so that the pose data lives on a substantially lower-dimensional manifold than the raw image. For example, FIG. 2 shows a pose tensor of shape (3, 14, 3). Indeed, in each of the time frames, 201, 202, and 203, there are 14 different keypoints detected along the human such as 204, 205, 206. Each of the keypoints is stored as an (x,y,z)-point with respect to some fixed coordinate system 207.

On the other hand, working with just pose data alone comes at the cost of losing contextual data within the image which could potentially be useful in helping a HAR model learn the desired action. A common problem though with many vision-based deep learning models is when trained on data from an RGB camera, the models learn features that are specific to the conditions of the production area during the time of recording, such as camera perspective and lighting. There are many forms of human pose data, but in general the above form is flexible and amenable to various transformations such as rotation, scaling, translation, and flipping. These transformations are used for proper training of machine learning models, as they can serve as normalization operations that can help a model's ability to generalize and moreover are relatively robust to the above-mentioned camera-specific issues. Moreover, extracting pose data from sensors such as RGB or depth cameras is achievable with current state-of-the-art methods in ML.

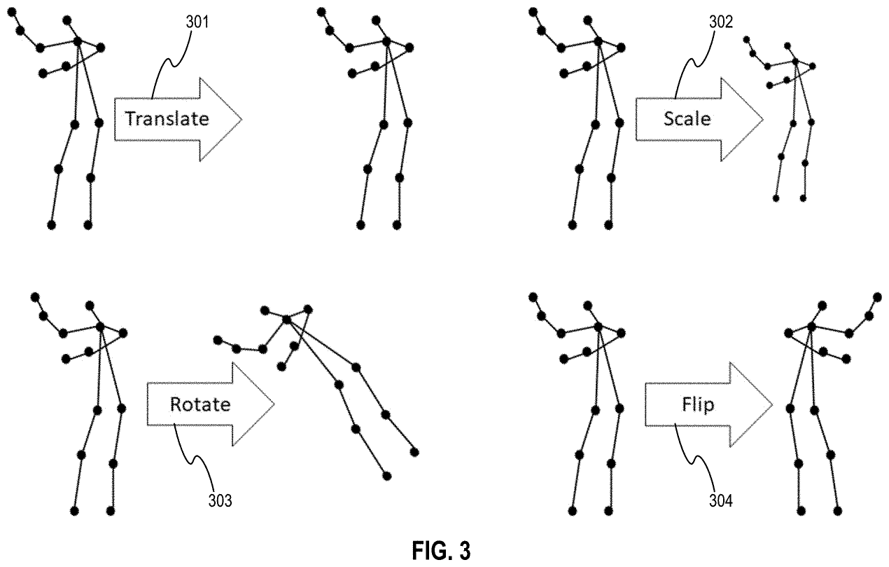

FIG. 3 illustrates an example of transformations to human pose data. Example transformations that can be conducted include translate 301, scale 302, rotate 303, and flip 304. Such transformations can be executed to align the pose data to a common perspective.

While human pose data has certainly been shown to be useful in developing accurate HAR models, many challenges remain, specifically in the Industrial Internet of Things (IIoT) field. In this setting, sensor data can be used to capture this worker movement, but the exact task and the nature of the work can change over time for any physical production area. Thus, deploying or developing models in these production areas can be difficult due to the dynamic setting the sensors are observing. Using effective HAR models often requires large amounts of resources as well due to the complicated architecture and large number of parameters that many deep learning models use. Using human pose data to solve problems concerning activity recognition is a well-studied problem. For example, graph convolutional networks leveraging spatio-temporal human pose data are a state-of-the-art method for HAR models. In some related art implementations, the importance of pose normalization is stressed for improved accuracy of HAR models—such as scale and rotation invariance, along with illumination concerns. However, most related art implementations do not consider the broader picture of trying to use HAR on a wider scale and are focused on building these models with particular setups, and so do not maximize the impact these models can have. In related art implementations there is a lack of a solution that can address all of these problems. The challenge of finding the optimal way to train multiple HAR models by appropriately leveraging the similarity in the movements of the different settings remains open. A technical consequence of a such a solution would be to reduce the amount of labeled data required for such models. Also, accounting for changes in conditions in the production areas using a suitable system of management for the HAR models remains difficult.

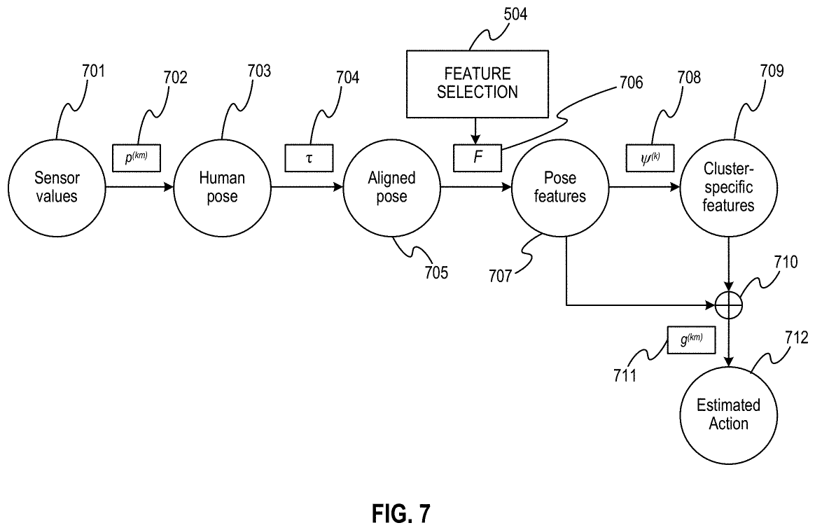

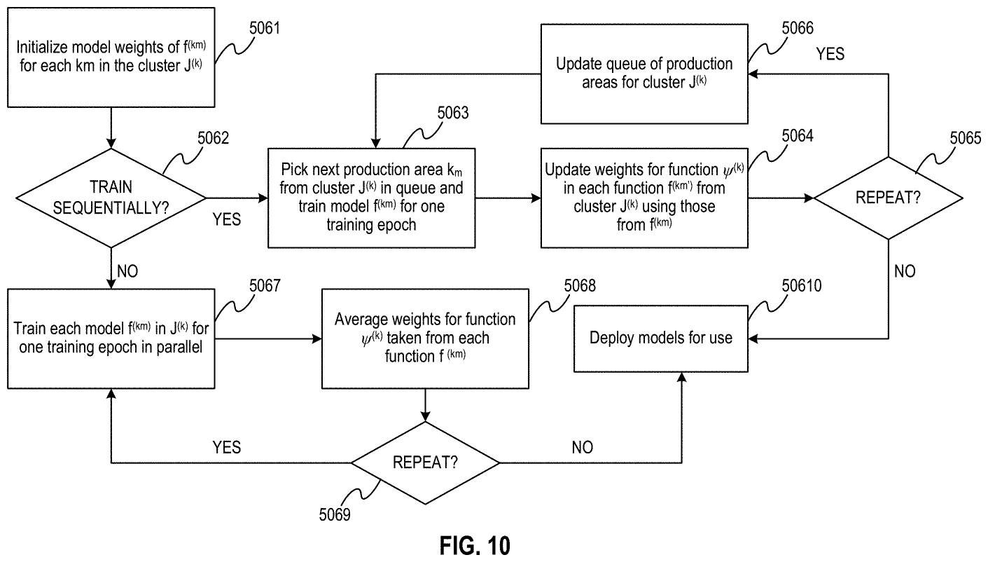

To address the above issues, example implementations described herein are directed to improving the efficiency of model learning in industrial businesses, in particular in the industrial setting. For example, in the factory floor 101 of FIG. 1, there can be many different types of processes executed in different physical areas (e.g., the production areas 102) of the factory. In particular, the physical areas can involve similar processes or similar processes. To produce more efficient model learning, the example implementations described herein cluster the sensed information and train the models belonging to the same cluster by sharing weights or other features (e.g., sequentially and/or in parallel) as illustrated in FIGS. 7 and 10.

Further, the example implementations utilize clustering based on features extracted from the pose data, which is then used to determine how the models are trained so as to maximize the training of HAR models based on the similarity in worker movement. By using such an approach in contrast to the related art, models can be efficiently and timely generated through the reduction of the amount of labeled data required for such models.

Suppose there are K production areas, and in each production area there is an interest in detecting an action from the action space [symbol] ^{(k)} for k=1, . . . , K. In general, the action spaces [symbol] ^{(k)} are not the same across the different production areas, even when there might be similarities. Building a separate model for each of the production areas may thereby miss out on the commonality between the sensor data (or pose data, etc.) X^{(k)} across the different production areas. Thus, even if [symbol] ^{(k)}∩ [symbol] ^{(k′)}=Ø, it is still possible that there is a high degree of similarity between the corresponding sensor data X^{(k)} and X^{(k′)}. In optimizing neural networks, a loss function [symbol] (θ; X, a) is minimized as a function of θ with respect to a labeled pair (X,a), where θ represents the trainable parameters of the neural network. Most optimization algorithms use a variant of stochastic gradient descent (SGD), where the parameters are updated according to the rule

$${θ}^{n e w} ← {θ}^{old} - η \frac{1}{N} {\sum }_{i = 1}^{N} {∇}_{θ} ℓ ( {θ}^{old} ; {X}_{i} , {a}_{i} ) .$$

The parameters in SGD can be updated according to an average of the gradient of the loss function [symbol] across a mini-batch of data [symbol] =(Xᵢ, aᵢ) If the Xᵢ in the mini-batch are drawn from production areas that are significantly different, the average gradient estimate above may have high variance during each iteration, which could impact training time and/or performance. This can be overcome with a significant amount of data or long enough training time or appropriate tuning (such as the scaling factor η), but due to the expensive data curation process, this may or may not be feasible.

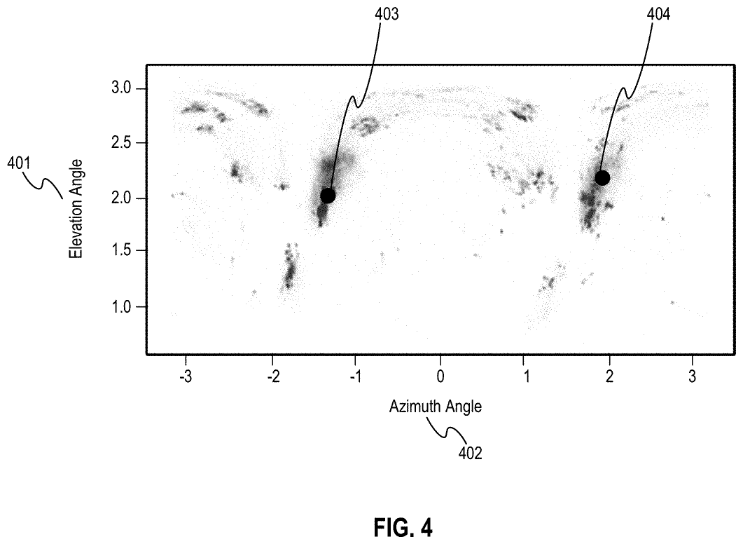

Example implementations thereby involve a method for aggregating and organizing sensor data from different production areas for effective training of machine learning models. By grouping together similar production areas appropriately, machine learning models can thereby be trained to identify different tasks. The example implementations begin by first observing that the distribution of features extracted from the pose data can be used to characterize the production area from which they were sampled. FIG. 4 illustrates an example distribution of features extracted from pose data of workers doing a specific task in certain area over some time period, in accordance with an example implementation. In FIG. 4, the elevation angle 401 and azimuth angle 402 with respect to a fixed reference frame are extracted from a joint angle within the human pose. Certain regions 403 and 404 appear within the pose distribution corresponding to poses that occurred more frequently in the sampled data within the single site. The pose distributions of multiple sites can be used to form clusters between the different sites. Certain regions in the pose distributions will be common across multiple sites, suggesting similar activity; thus it is feasible to use the similarity of the pose distributions to cluster the different sites.

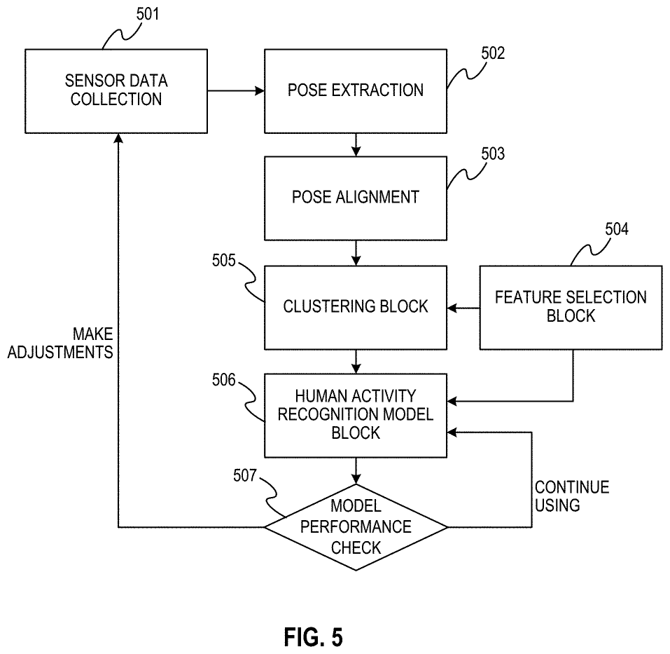

Now, given M production areas, example implementations devise a strategy for clustering these production areas together and training them based on their region similarities. It is assumed throughout that in each production area, the sensor data is observing human workers, and that from this sensor data human pose data can be extracted from each worker in the sensor's field of view such that it can be represented as a spatio-temporal tensor as shown in FIG. 2. A high-level overview of the proposed solution is depicted in FIG. 5.

FIG. 5 illustrates a high-level solution for the management of HAR models, in accordance with an example implementation. After sensor data is collected in each production area 501, pose data for each worker is pulled from this sensor data 502 and appropriately aligned 503 so that the coordinate system used to describe the pose data is the same across the different production areas. Pose data is extracted 502 in a number of ways by either directly capturing keypoint information using specific sensors (e.g., motion capture sensors) or estimating keypoint information using a machine learning trained on data from other sensors in the production area (e.g., RGB cameras or LiDAR)—but it is assumed that at least some method for extracting poses of humans in the available frames is possible. The aligning is performed using a suitable combination of transformations of the human pose data, ranging from translation 301, rotation 302, scaling 303, and flipping 304 as depicted in FIG. 3.

Then, based on features chosen 504 for the production areas in question, the example implementations cluster production areas 505 based on the similarity of these features that are extracted from the pose data. After clustering the production areas, example implementations train or use a model 506 for each production area by jointly considering models within each cluster, even though the goal of the model for each production area may be different. After some time, each model is evaluated 507, and depending on the performance example implementations can decide to adjust the clustering or continue using each model for the task at hand.

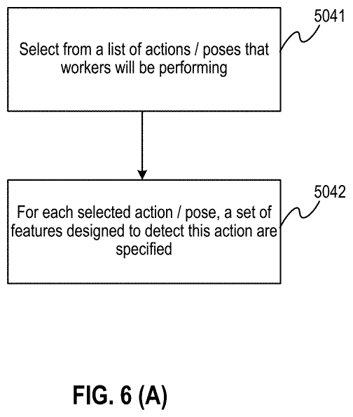

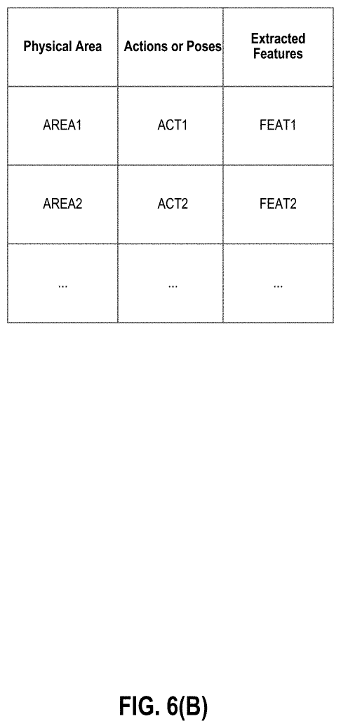

By clustering based on similarity of the extracted features rather than the poses themselves, this creates some flexibility in how the exact clusters are produced. The feature extraction process 504 is depicted in FIG. 6 (A). FIG. 6 (A) illustrates an example flow of the feature selection block, in accordance with an example implementation. In the following, and in example implementations described herein, pose is in reference to a particular configuration of human joints and limbs (e.g., bent over, hands stretched, elbows up, hands above head). Action is in reference to a sequence of poses evolving over time (e.g., bending over to pick something up, grabbing motion, tightening something, hitting something, lifting motion). Features are in reference to types of data designed to detect the chosen actions/poses (e.g., angle between leg and spine, rate of change of hand from center of body, dot product of one limb vector with cross product of two others, height of head from ground, etc.). A selection of a set of actions/poses 5041 that are performed in the different production areas by the workers is provided based on their own knowledge of the tasks the workers will be performing. Features that are designed to detect the chosen actions/poses (e.g., this could be done in a pre-set manner as defined through the interface 109, either automatically or by an engineer or a factory supervisor, and provided ahead of time as it does not require a supervisor to look at the data, or in an automated or manual real-time manner in accordance with the desired implementation) are then specified for feature extraction 5042 when both clustering 505 and training the HAR models 506. For instance, suppose that in some work production areas the emphasis lies in picking up certain items off the ground. In this setting, poses where the person is bending over might be of increased interest, which can be detected by looking at the angle the torso makes with the lower body, and so could be extracted via the feature selection process. In another example, if the actions on the floor will require lots of fine motor movement, we can extract features that look at finger movement—specifically, if say the action is screw tightening, rotation of the fingers/hand/wrist could be extracted.

FIG. 6 (B) illustrates an example of feature selection input, in accordance with an example implementation. As illustrated in FIG. 6 (B), for a given physical area, the interface 109 facilitates the selection of actions/poses that is representative of the tasks being conducted by the workers in the given physical area. Once the actions/poses are provided via the interface 109, features can be extracted from the actions/poses using any feature extraction technique as known in the art. The selection of actions/poses can be facilitated through interface 109, which can be a user interface in accordance with any desired implementation as known in the art. The information in FIG. 6 (B) can be provided in a pre-set manner or in an ad hoc manner, in accordance with an example implementation.

Suppose there is a need to cluster M production areas into K different groups. For each k=1, . . . , K,

[symbol]

^{(k)}={m|production area m belongs to cluster k}.

Within each cluster, the individual tasks (which are specified by their action spaces [symbol] ^{(k}^{ₘ}⁾) for classification are not necessarily the same. Assume that the model

$${f}^{( {k}_{m} )} : {ℝ}^{{N}^{( {k}_{m} )}} \to {ℝ}^{\vert {𝒜}^{( {k}_{m} )} \vert}$$

used for classification of sensor data X^{(k}^{ₘ}⁾ from production area kₘ∈ [symbol] ^{(k)} takes the following form:

ƒ^{(k}^{ₘ}⁾=g^{(k}^{ₘ}⁾(ψ^{(k)}(\hat{X}^{(k}^{ₘ}⁾)⊕\hat{X}^{(k}^{ₘ}⁾), where \hat{X}^{(k}^{ₘ}⁾=F(τ(p^{(k}^{ₘ}⁾(X^{(k}^{ₘ}⁾))).

Here, the symbol ⊕ denotes concatenation.

FIG. 7 illustrates a human activity recognition model architecture, in accordance with an example implementation. The decomposition above in FIG. 7 can be explained as follows.

The function 702 p^{(k}^{ₘ}⁾: [symbol] ^{T×N}^{^{(k}}^{m}^{⁾}→ [symbol] ^{T×N×C} takes the sensor values X^{(k}^{ₘ}⁾ 701 observed in production area kₘ over T timestamps and extracts from this data a human pose estimation 703 at each of the T timestamps. This is the same as step 502 taken in FIG. 5, but just applied to a single person (rather than the poses of all possible people in the frame).

The function 704 τ: [symbol] ^{T×N×C}→ [symbol] ^{T×N×C} performs a suitable combination of transformations to align the human pose 703 to a common perspective 705. In the same way as above, this is the same as step 503 taken in FIG. 5, but only applied to a single person.

The function 706 F: [symbol] ^{T×N×C}→ [symbol] ^{D} is the feature extraction step 504 that produces features of interest 707 from the aligned pose tensor 705 of shape (T,N,C) modeling the spatio-temporal human pose graph. Examples of features extracted could be time-dependent relationships, bone angle vectors, local coordinate changes of joints, and so on.

The function 708 ψ^{(k)}: [symbol] ^{D}→ [symbol] ^{L}^{^{(k)}} the key function that processes the feature-extracted pose data 707 in the proposed solution. This could be viewed as another feature extraction function, but this function has the property that only data from cluster [symbol] ^{(k)} is fed into this function. Thus, for the purposes of training, ψ^{(k)} ultimately only learns cluster-specific features 709 based on data from [symbol] ^{(k)} and not all production areas.

Lastly, the function 711 g^{(k}^{ₘ}⁾: [symbol] ^{L}^{^{(k)}}⊕ [symbol] ^{D}→ [symbol] | learns to estimate the desired action 712 based on a concatenated vector 710 involving the cluster-specific feature data 609 and the feature-extracted pose data 707. As input to this function g^{(k}^{ₘ}⁾ only data from production area kₘ will be input into this function, unless there are other production areas within cluster k with the same action space [symbol] ^{(k}^{ₘ}⁾, in which case the model g^{(k}^{ₘ}⁾ can be re-used for these production areas as well.

The central function in performing human activity recognition in the above framework is the function 708 ω^{(k)} that processes the input space of feature extracted poses \hat{X}^{(k}^{ₘ}⁾=F(τ(p^{(k}^{ₘ}⁾(X^{(k}^{ₘ}⁾))) 707 for each kₘ in [symbol] ^{(k)}.

Naively clustering based on the distribution of the raw sensor data 701 X^{(k)} will lead to problems in that it will not be able to successfully capture similarities in the observed workers in each frame without careful preprocessing. For example, suppose there are two production areas k and k′ that observe the same tasks performed by workers but in different settings. One would expect that the sensor data X^{(k)} and X^{(k′)} have similar distributions [symbol] ^{(k)} and [symbol] ^{(k′)} respectively, but unless the lighting conditions, camera perspective, occlusions, etc. are similar for each other production area, the distributions could look significantly different from one another. With proper processing of the data, some of these issues can be resolved, but often come at a cost in interpretability of the data.

One could instead consider the distribution of \hat{X}^{(k)}, the feature-extracted pose data from production area k. By comparing the distributions \hat{X}^{(k)}˜ [symbol] ^{(k)} and \hat{X}^{(k′)}˜ [symbol] ^{(k′)} as opposed to [symbol] ^{(k)} and [symbol] ^{(k′)}, the effects that the conditions around the production area may have on the observed data can thereby be removed. Moreover, the fact that the random variables \hat{X}^{(k)} have a support that lives on a significantly lower-dimensional manifold than the corresponding X^{(k)} cab help with clustering, as large-dimensional clustering is often problematic.

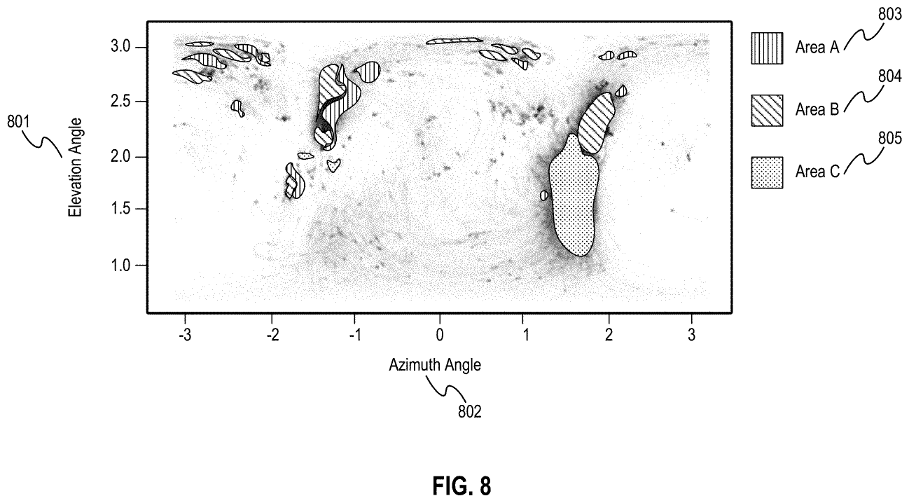

FIG. 8 illustrates an example comparison of different feature-extracted pose distributions, in accordance with an example implementation. In FIG. 8, an example of a comparison of different distributions of feature-extracted pose data is illustrated. Batch data from each of the areas A, B, C (803, 804, 805) is collected, and certain features 801, 802 are extracted. By looking at how the distributions are different or similar, areas A (803) and B (804) can be clustered together, whereas area C (805) is sufficiently different and so deserves its own cluster.

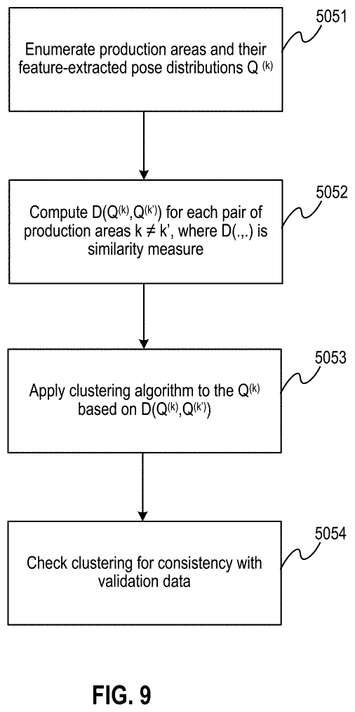

FIG. 9 illustrates an example of the clustering block, in accordance with an example implementation. Clustering the production areas together is illustrated in FIG. 9, where an appropriate similarity measure on the space of features extracted from the pose distributions is applied pairwise. First, each production area and the corresponding distribution of feature-extracted pose data is enumerated 5051. After this, a similarity measure D (·,·) between probability distributions is identified, and for each pair of production areas k, k′ we can calculate D( [symbol] ^{(k)}, [symbol] ^{(k′)}) 5052. Examples of such similarity measures include KL-divergence, JS-divergence, mutual information, Wasserstein distance, and so on. After the comparisons are made between the distributions [symbol] ^{(k)}, any clustering algorithm 5053 can be effectively applied that only relies on a notion of distance between its points (e.g., K-means), although some care must be taken as some similarity measures for probability distributions are not true distances (e.g., KL-divergence is not symmetric). In this way the clusters [symbol] ^{(k)} for each k=1, . . . , K can be produced. The above setting should also accommodate the case where clusters already exist, but only some of the production areas need to be assigned to new clusters, as in a previous iteration of our solution that requires updates. After producing the clustering, the consistency can be checked by using validation data 5054 to see if the clustering is consistent across batches.

Once clustering 505 is accomplished, such models 506 can be trained using previously acquired labeled data. FIG. 10 illustrates a flow for the human activity recognition model block 506, in accordance with an example implementation. Within a cluster, the weights are initialized 5061 for each model. If the model has already been used before, the weights can be reused or randomly initialized.

In the event each model can be trained sequentially 5062 according to some queue of production areas (YES), the models can be trained in the cluster as follows (e.g., in the deep learning case split learning methods are similar): First pick the production area kₘ at the front of the queue 5063, and train model ƒ^{(k}^{ₘ}⁾ for a training epoch. Then, for the rest of the models ƒ^{(k}^{_{m′}}⁾ within this cluster [symbol] ^{(k)}, the weights of ω^{(k)} are updated using those from ƒ^{(k}^{ₘ}⁾ 5064. If another training epoch 5065 is to be updated, the queue of productions areas for this cluster [symbol] ^{(k)} 5066 is updated before going onto the next production area's model. Sequential training may be decided upon based on the availability of compute resources, where if resources are limited, then it might be desirable to train the models sequentially. On the other hand, if resources are plentiful, training the models in parallel may be more feasible. Examples of criteria for the availability of compute resources can involve, but are not limited to, any kind of function based on one nor more of the availability of hardware processor resources, memory availability, and so on.

If the models are not to be trained sequentially, but in parallel (NO), then within each cluster the model(s) ƒ^{(k}^{ₘ}⁾ can be trained individually for each kₘ in [symbol] ^{(k)} 5067. After this, the flow averages 5068 the weights of ψ^{(k)} from each function ƒ^{(k}^{ₘ}⁾. Indeed, by training ƒ^{(k}^{ₘ}⁾ (and hence also ψ^{(k)}) on data from production area kₘ, local parameters W^{(k,k}^{ₘ}⁾ can be obtained for the function ψ^{(k)}, which can then by updated into global weights via some type of aggregation function such as an averaging of the form

$${W}^{( k )} = \frac{1}{\vert {𝒥}^{( k )} \vert} {\sum }_{{k}_{m} ∈ {𝒥}^{( k )}} {W}^{( k , {k}_{m} )}$$

that is then shared across each of the ƒ^{(k}^{ₘ}⁾—this is the situation in federated learning. This averaging of the weights into a common function ψ^{(k)} for the entire cluster can be repeated 5069. In either the sequential learning or parallel learning case, if there is a need to not repeat the training after a certain number of epochs (NO), the models can be then deployed for use 50610. Training in either case could be conducted by sending all the data from a cluster to a centralized server where the training is performed or the data can remain on local edge devices, in which case distributed machine learning methods such as federated learning or split learning mentioned above may more particularly apply (e.g., if privacy is a concern).

Since each production area kₘ is likely to change due to the dynamic nature of factory conditions (e.g., in the morning the production line may differ from what is produced during the evening), the model ƒ^{(k}^{ₘ}⁾ may need to change. That is, the production area kₘ at time t may be different than at time t+1 for at least a couple of reasons:
1) [symbol] ^{(k}^{ₘ}⁾[t]≠ [symbol] ^{(k}^{ₘ}⁾ [t+1]: The nature of the task may have changed during the time elapsed, and so it may no longer be the case that applying model ƒ^{(k}^{ₘ}⁾ is of interest.
2) [symbol] ^{(k}^{ₘ}⁾[t]≠ [symbol] ^{(k}^{ₘ}⁾[t+1]: The distribution of the feature-extracted pose data may have changed during this time, and so even if the task is the same, the pose data may appear slightly different. For instance, this could occur if the production line task(s) remain the same, but the individual workers have changed. This will result in a shift in the pose distribution.

In the latter case, it may be desirable to re-use the model ƒ^{(k}^{ₘ}⁾ and keep the production area in the same cluster, but depending on model performance, additional labeled data may be required. However, with sufficient generalization capacity, the model's ability to adapt to a new stream of workers or change in production area despite having the same task may not prove to be too formidable of a challenge for the model. This can be periodically re-evaluated by a human inspector that evaluates the model based on its predictions to determine whether more labeled data is required.

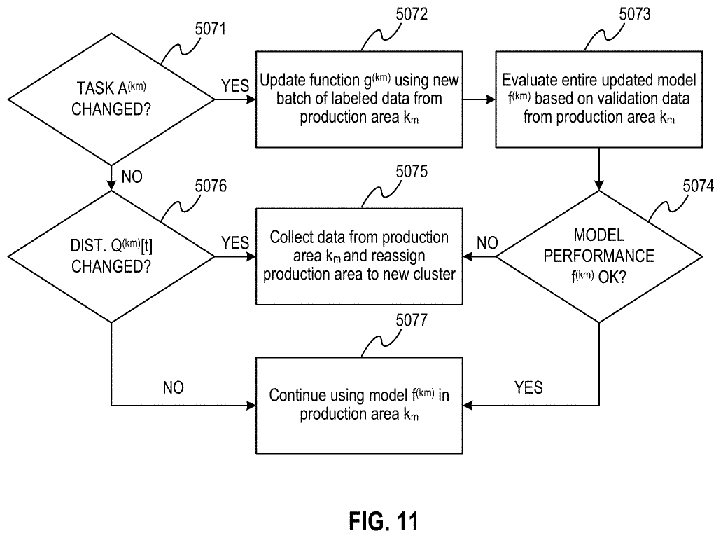

FIG. 11 illustrates an example flow of the model performance check 507, in accordance with an example implementation. The process for evaluating model performance and updating models/clusters is illustrated in FIG. 11. Initially, it is determined at 5071 whether the action space [symbol] ^{(k}^{ₘ}⁾ within production area kₘ has changed. In an example implementation, the determination at 5071 can be based on updates provided through interface 109 with information provided by a supervisor about the task that will occur in the site being monitored. In another example implementation, the determination at 5071 can be automated in accordance with any desired implementation. For example, if a camera observing a certain line has its production shifted from producing item A to item B, this shift would constitute the task change, and changes to the pose distributions will thereby be observed. Based on any such determination, clusters can be updated based on a determination of a change to one or more of the plurality of physical areas of the action space.

If so (YES), then rather than immediately reassigning production area kₘ to a new cluster, the flow proceeds to 5072 to update the last layer g^{(k}^{ₘ}⁾ of model ƒ^{(k}^{ₘ}⁾ using a new batch of labeled data from production area kₘ.

Upon passing a suitable test on validation data 5073, if the performance of model ƒ^{(k}^{ₘ}⁾ 5074 is suitable for estimating the tasks being performed in production area kₘ (YES), then the flow proceeds to 5077 and uses model ƒ^{(k}^{ₘ}⁾. If not (NO), then the flow starts over and collect data from production area kₘ, upon which the flow can reassign the production area to a new cluster 5075.

On the other hand, if the task has not changed at 5071 (NO), then the flow proceeds to 5076 to consider whether the distribution of feature-extracted pose data [symbol] ^{(k}^{ₘ}⁾[t] is different from [symbol] ^{(k}^{ₘ}⁾[t+1] using one of a variety of similarity measures as mentioned previously. With regards to the flow at 5076, example implementations can determine if the distribution has changed by using a similarity metric in accordance with the desired implementation, including the same metric used to cluster the different distributions. If the difference is beyond some threshold, then the difference indicates the distribution has indeed changed. If so (YES), then the flow should reassign the production area kₘ to a new cluster after collecting more data 5075. If not (NO), then the flow can continue using model ƒ^{(k}^{ₘ}⁾ in production area kₘ at 5077.

Example implementations provide systems and methods for optimizing management of multiple HAR models by clustering production areas with human activity based on similarity between the distributions of certain features of extracted human pose data, which contributes to reduced costs by efficiently training models.

As described herein, the example implementations can obtain sensed data for a plurality of time periods from a plurality of specific physical areas as illustrated in FIG. 1. The example implementations can then extract posture distribution data from the sensed data of each physical area as illustrated in FIG. 2 and FIG. 3. Subsequently, the example implementations clustering posture distribution data based on its similarity as illustrated in FIGS. 4 and 7, and then train a model for each posture distribution (e.g., of specific physical area), wherein at least part of the weights are shared among plurality of models belonging to the same cluster (e.g., and from a different physical area).

Furthermore, example implementations receive the input of feature selection, and in the clustering is done based on the received feature selection as illustrated in FIG. 6 (A) and FIG. 6 (B).

In example implementations, the extracted posture distribution data can be aligned to a common perspective as illustrated in FIGS. 3 and 7.

In example implementations, there is a feedback mechanism for updating clusters in which clusters are updated based on changes in environment as illustrated in FIG. 11.

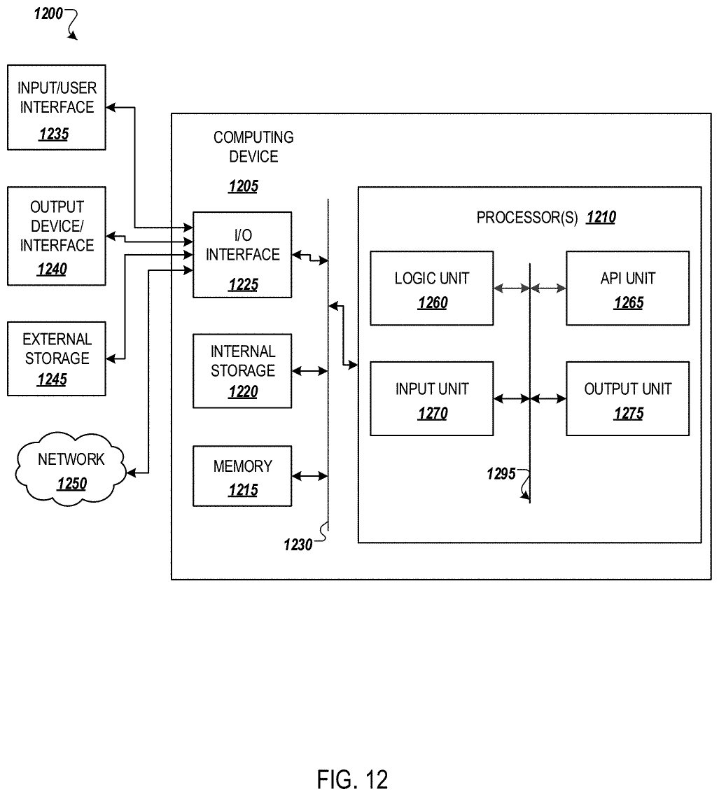

FIG. 12 illustrates an example computing environment with an example computer device suitable for use in some example implementations, such as an analytics server 108 as illustrated in FIG. 1.

Computer device 1205 in computing environment 1200 can include one or more processing units, cores, or processors 1210, memory 1215 (e.g., RAM, ROM, and/or the like), internal storage 1220 (e.g., magnetic, optical, solid state storage, and/or organic), and/or I/O interface 1225, any of which can be coupled on a communication mechanism or bus 1230 for communicating information or embedded in the computer device 1205. I/O interface 1225 is also configured to receive images from cameras or provide images to projectors or displays, depending on the desired implementation.

Computer device 1205 can be communicatively coupled to input/user interface 1235 and output device/interface 1240. Either one or both of input/user interface 1235 and output device/interface 1240 can be a wired or wireless interface and can be detachable. Input/user interface 1235 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 1240 may include a display, television, monitor, printer, speaker, braille, or the like. In some example implementations, input/user interface 1235 and output device/interface 1240 can be embedded with or physically coupled to the computer device 1205. In other example implementations, other computer devices may function as or provide the functions of input/user interface 1235 and output device/interface 1240 for a computer device 1205.

Examples of computer device 1205 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 1205 can be communicatively coupled (e.g., via I/O interface 1225) to external storage 1245 and network 1250 for communicating with any number of networked components, devices, and systems, including one or more computer devices of the same or different configuration. Computer device 1205 or any connected computer device can be functioning as, providing services of, or referred to as a server, client, thin server, general machine, special-purpose machine, or another label.

I/O interface 1225 can include, but is not limited to, wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 1200. Network 1250 can be any network or combination of networks (e.g., the Internet, local area network, wide area network, a telephonic network, a cellular network, satellite network, and the like).

Computer device 1205 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computer device 1205 can be used to implement techniques, methods, applications, processes, or computer-executable instructions in some example computing environments. Computer-executable instructions can be retrieved from transitory media and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 1210 can execute under any operating system (OS) (not shown), in a native or virtual environment. One or more applications can be deployed that include logic unit 1260, application programming interface (API) unit 1265, input unit 1270, output unit 1275, and inter-unit communication mechanism 1295 for the different units to communicate with each other, with the OS, and with other applications (not shown). The described units and elements can be varied in design, function, configuration, or implementation and are not limited to the descriptions provided.

In some example implementations, when information or an execution instruction is received by API unit 1265, it may be communicated to one or more other units (e.g., logic unit 1260, input unit 1270, output unit 1275). In some instances, logic unit 1260 may be configured to control the information flow among the units and direct the services provided by API unit 1265, input unit 1270, output unit 1275, in some example implementations described above. For example, the flow of one or more processes or implementations may be controlled by logic unit 1260 alone or in conjunction with API unit 1265. The input unit 1270 may be configured to obtain input for the calculations described in the example implementations, and the output unit 1275 may be configured to provide output based on the calculations described in example implementations.

Processor(s) 1210 can be configured to, for receipt of sensor data of a plurality of workers operating across a plurality of physical areas from a plurality of sensors as illustrate in FIGS. 1 to 3, extract pose data of the plurality of workers from the sensor data, the pose data indicative of one or more poses of the plurality of workers; determine pose distributions of each site from the extracted pose data; cluster the pose distributions based on similarity to form a plurality of clusters; and train a model for each pose distribution of each of the plurality of physical areas to generate a plurality of models, wherein at least a portion of weights used in the plurality of models are shared among ones of the plurality of models belonging to a same cluster of the plurality of clusters and from different ones of the plurality of physical areas as illustrated in FIGS. 7 to 10. Through such clustering of pose distributions based on similarity (e.g., clustering the pose distributions based on similar features from feature selection), the example implementations can thereby maximize training of HAR models based on similarity in worker movement by reducing the amount of labeled data required for such models. The reduction of the amount of labeled data thereby leads to faster training and generation of models for the factory floor.

Processor(s) 1210 are configured to process feature selection; wherein the processor(s) 1210 is configured to cluster the pose distributions based on the similarity is done based on the feature selection as illustrated in FIGS. 6 (A) and 6 (B), the feature selection conducted based on actions or poses of the plurality of workers.

Depending on the desired implementation, the pose distributions are aligned to a common perspective as illustrated in FIG. 3.

Processor(s) 1210 can be configured to update the plurality of clusters based on a determination of a change to one or more of the plurality of physical areas based on changes to the pose distributions as illustrated in FIG. 11.

Depending on the desired implementation, the change to the one or more of the plurality of physical areas is one or more of a task change and a distribution change as illustrated in FIG. 11. For the determination of the change being the task change, processor(s) 1210 can be configured to update the plurality of clusters by updating the training of the model for the each of the pose distributions of the changed one or more of the plurality of physical areas from labeled data from the changed one or more of the plurality of physical areas as illustrated at 5071 to 5073 in FIG. 11. For the determination of the change being the distribution change, processor(s) 1210 can be configured to update the plurality of clusters by reassigning the model for the each of the pose distributions of the changed one or more of the plurality of physical areas to another one of the plurality of clusters as illustrated at 5075 and 5076 of FIG. 11.

Processor(s) 1210 can be configured to train the model for the each of the pose distributions of the each of the plurality of physical areas to generate the plurality of models in parallel for a determination that compute resources are available to train the model for the each of the pose distributions of the each of the plurality of physical areas in parallel, and sequentially for the determination that the compute resources are not available to train the model for the each of the pose distributions of the each of the plurality of physical areas in parallel as illustrated in FIG. 10.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed is:

1. A method, comprising:
for receipt of sensor data of a plurality of workers operating across a plurality of physical areas from a plurality of sensors:
extracting pose data of the plurality of workers from the sensor data, the pose data indicative of one or more poses of the plurality of workers;
determining pose distributions of each site from the extracted pose data;
clustering the pose distributions based on similarity to form a plurality of clusters; and
training a model for each of the pose distributions of each of the plurality of physical areas to generate a plurality of models, wherein at least a portion of weights used in the plurality of models are shared among ones of the plurality of models belonging to a same cluster of the plurality of clusters and from different ones of the plurality of physical areas.

2. The method of claim 1, further comprising processing feature selection; wherein the clustering the pose distributions based on the similarity is done based on the feature selection, the feature selection conducted based on actions or poses of the plurality of workers.

3. The method of claim 1, wherein the pose distributions are aligned to a common perspective.

4. The method of claim 1, further comprising updating the plurality of clusters based on a determination of a change to one or more of the plurality of physical areas based on changes to the pose distributions.

5. The method of claim 4, wherein the change to the one or more of the plurality of physical areas is one or more of a task change and a distribution change;
wherein for the determination of the change being the task change, the updating the plurality of clusters comprises updating the training of the model for the each of the pose distributions of the changed one or more of the plurality of physical areas from labeled data from the changed one or more of the plurality of physical areas;
wherein for the determination of the change being the distribution change, the updating the plurality of clusters comprises reassigning the model for the each of the pose distributions of the changed one or more of the plurality of physical areas to another one of the plurality of clusters.

6. The method of claim 1, wherein the training the model for the each of the pose distributions of the each of the plurality of physical areas to generate the plurality of models, is conducted in parallel for a determination that compute resources are available to train the model for the each of the pose distributions of the each of the plurality of physical areas in parallel, and conducted sequentially for the determination that the compute resources are not available to train the model for the each of the pose distributions of the each of the plurality of physical areas in parallel.

7. A non-transitory computer readable medium, storing instructions to execute a process, the instructions comprising:
for receipt of sensor data of a plurality of workers operating across a plurality of physical areas from a plurality of sensors:
extracting pose data of the plurality of workers from the sensor data, the pose data indicative of one or more poses of the plurality of workers;
determining pose distributions of each site from the extracted pose data;
clustering the pose distributions based on similarity to form a plurality of clusters; and
training a model for each pose distribution of each of the plurality of physical areas to generate a plurality of models, wherein at least a portion of weights used in the plurality of models are shared among ones of the plurality of models belonging to a same cluster of the plurality of clusters and from different ones of the plurality of physical areas.

8. The non-transitory computer readable medium of claim 7, the instructions further comprising processing feature selection; wherein the clustering the pose distributions based on the similarity is done based on the feature selection, the feature selection conducted based on actions or poses of the plurality of workers.

9. The non-transitory computer readable medium of claim 7, wherein the pose distributions are aligned to a common perspective.

10. The non-transitory computer readable medium of claim 7, further comprising updating the plurality of clusters based on a determination of a change to one or more of the plurality of physical areas based on changes to the pose distributions.

11. The non-transitory computer readable medium of claim 10, wherein the change to the one or more of the plurality of physical areas is one or more of a task change and a distribution change;
wherein for the determination of the change being the task change, the updating the plurality of clusters comprises updating the training of the model for the each of the pose distributions of the changed one or more of the plurality of physical areas from labeled data from the changed one or more of the plurality of physical areas;
wherein for the determination of the change being the distribution change, the updating the plurality of clusters comprises reassigning the model for the each of the pose distributions of the changed one or more of the plurality of physical areas to another one of the plurality of clusters.

12. The non-transitory computer readable medium of claim 7, wherein the training the model for the each of the pose distributions of the each of the plurality of physical areas to generate the plurality of models, is conducted in parallel for a determination that compute resources are available to train the model for the each of the pose distributions of the each of the plurality of physical areas in parallel, and conducted sequentially for the determination that the compute resources are not available to train the model for the each of the pose distributions of the each of the plurality of physical areas in parallel.

13. An apparatus, comprising:
a processor, configured to:
for receipt of sensor data of a plurality of workers operating across a plurality of physical areas from a plurality of sensors:
extract pose data of the plurality of workers from the sensor data, the pose data indicative of one or more poses of the plurality of workers;
determine pose distributions of each site from the extracted pose data;
cluster the pose distributions based on similarity to form a plurality of clusters; and
train a model for each pose distribution of each of the plurality of physical areas to generate a plurality of models, wherein at least a portion of weights used in the plurality of models are shared among ones of the plurality of models belonging to a same cluster of the plurality of clusters and from different ones of the plurality of physical areas.

14. The apparatus of claim 13, the processor configured to process feature selection; wherein the processor is configured to cluster the pose distributions based on the similarity is done based on the feature selection, the feature selection conducted based on actions or poses of the plurality of workers.

15. The apparatus of claim 13, wherein the pose distributions are aligned to a common perspective.

16. The apparatus of claim 13, the processor configured to update the plurality of clusters based on a determination of a change to one or more of the plurality of physical areas based on changes to the pose distributions.

17. The apparatus of claim 16, wherein the change to the one or more of the plurality of physical areas is one or more of a task change and a distribution change;
wherein for the determination of the change being the task change, the processor is configured to update the plurality of clusters by updating the training of the model for the each of the pose distributions of the changed one or more of the plurality of physical areas from labeled data from the changed one or more of the plurality of physical areas;
wherein for the determination of the change being the distribution change, the processor is configured to update the plurality of clusters by reassigning the model for the each of the pose distributions of the changed one or more of the plurality of physical areas to another one of the plurality of clusters.

18. The apparatus of claim 13, wherein the processor is configured to train the model for the each of the pose distributions of the each of the plurality of physical areas to generate the plurality of models in parallel for a determination that compute resources are available to train the model for the each of the pose distributions of the each of the plurality of physical areas in parallel, and sequentially for the determination that the compute resources are not available to train the model for the each of the pose distributions of the each of the plurality of physical areas in parallel.
